(19) United States
(12) Patent Application Publication
(10) Pub. No.: US 2005/0102308 A1
(43) Pub. Date: May 12, 2005

(54) Adaptively interfacing with a data repository

(75) Inventors: Michael John Sykes, Aldgate (AU); Daniel Seth Weinstein, Flemington Victoria (AU); Jason Scott Beer, Hawthorne East (AU)

Correspondence Address: BURNS DOANE SWECKER & MATHIS L L P, POST OFFICE BOX 1404, ALEXANDRIA, VA, 22313-1404, US

(73) Assignee: Tenix Investments Pty Ltd, North Sydney (AU)

(21) Appl. No.: 10/677,297

(22) Filed: Oct. 3, 2003

(30) Foreign Application Priority Data
Oct. 4, 2002 (AU) 2002951909

(51) Int. Cl. G06F 7/00

(52) U.S. Cl. 707/102

(57) ABSTRACT

A method, a system, and a computer program product for adaptively interfacing with a data repository are disclosed. A data repository having associated meta-data is provided. The user interface is dynamically generated having interface elements that are dependent upon the meta-data. Operation of the interface is controlled by events that also are dependent upon data in the data repository and the meta-data. The user interface may be accessed using a browser, and web pages may be generated for delivery to the browser to provide the user interface.

### FIELD OF THE INVENTION

The present invention relates generally to database systems, and in particular to data warehousing techniques.

### BACKGROUND

All types of organisations, business entities, and persons may own legacy database systems that have been acquired at different times. A business may rely upon a particular database or transaction system to handle data aggregation and processing functions for a part of a business. Because of investment, knowledge, and experience with that system, an organisation or entity may choose not to replace such a system, for example, simply to avail itself of the stability of the system. Later, another database or transaction system may be acquired and used to handle a different aspect of the business. In this manner, an entity may ultimately operate a number of database systems that do not interact well, or at all, with one another. In a similar manner, an entity may have its own database or transaction system and need to interact with a number of different database or transaction systems of other entities. For example, a number of entities may be working collaboratively on a project, but each have their own database or transaction systems.

One approach to resolving this problem is to mandate the use of a standard database system throughout the entity or entities. However, this may not be possible or desirable for a number of reasons. For example, an entity working collaboratively with others for a short-term project may consider this to be too onerous of a requirement and therefore unjustifiable.

Data warehouses have attempted to address this problem to collect data from various sources, but suffer from a number of disadvantages. However, such a data warehouse produces mismatches in the data. This results from errors in the data itself (e.g. due to data entry problems), synchronization problems (e.g., a database may not yet have been amended), and conceptual differences. Relevant conceptual differences include like fields not having the same name, unlike fields having the same name, like fields having different definitions and/or formats, and like entities having different attributes, to name a few.

There has been little synergy between various databases in such circumstances, and users may need to learn a number of different application to find information the users need from such disparate databases.

A further difficulty with such disparate database systems is that each typically has a different interface for the particular database system. Consequently, users must learn a number of different interfaces and become knowledgeable in the nuances of the different interfaces when looking for the same thing across several systems.

Existing user interfaces are written to suit particular datasets. Most often navigation through various screens starts with a menu, from which users select the next screen. This functionality is hardcoded for the particular dataset. Consequently, changes to the data tier require corresponding changes to the application. This means that (1) the user interface is only useful for the original dataset, (2) significant changes to the dataset, or a new dataset, often require a complete rewrite of the user interface, and (3) maintenance and modifications are high cost.

Thus, a need clearly exists for an improved interface technology for accessing data in a data repository that is adaptable to the content of the data repository.

### SUMMARY

In accordance with a first aspect of the invention, a method of providing an adaptive user interface to a data repository is disclosed. A data repository is provided having associated meta-data. The user interface is dynamically generated having interface elements that are dependent upon the meta data. Operation of the interface is controlled by events that also are dependent upon data in the data repository and the meta-data. A browser may be used to access the user interface using a browser, and web pages may be generated for delivery to the browser to provide the user interface.

Preferably, the generating step comprises the steps of: checking the data repository to ensure the database has associated meta-data, the meta-data defining relationships in the data repository; and building a menu as a tree object using the meta-data, levels in the tree being built from the meta-data.

Preferably, the interface elements comprise a main menu, and further comprising the step of building the main menu dependent upon the meta data, the main menu being an expandable, hierarchically structured object. A search screen, a list screen or a detail page may be invoked if a menu item is selected.

The meta-data may comprise any one or more of the following: sort order, display name, hierarchy, table ID, target object, navigation URL, and initial expansion.

In accordance with further aspects of the invention, there are an apparatus and a computer program product for providing an adaptive user interface to a data repository, in accordance with the method of the foregoing aspect.

### BRIEF DESCRIPTION OF THE DRAWINGS

A small number of embodiments of the invention are described hereinafter with reference to the drawings, in which:

FIG. 1 is a block diagram of system utilising an interface that adaptively accesses and displays data in a data repository;

FIG. 2 is a flow diagram illustrating the process of adaptively interfacing with a data repository of FIG. 1;

FIGS. 3-12 are screenshots illustrating various aspects of the user interface produced by the process of FIG. 2;

FIG. 13 is a block diagram of a general-purpose computer system with which embodiments of the invention may be practiced; and

FIG. 14 is a flow diagram illustrating a process of providing an adaptive user interface to a data repository.

### DETAILED DESCRIPTION

Methods, systems, and computer program products for adaptively interfacing with a data repository are described. Numerous specific details are set forth in the following description comprising data interchange formats, database systems, and the like. However, it will be apparent to those skilled in the art in the light of this disclosure that modifications and/or substitutions may be made without departing from the scope and spirit of the invention. In other instances, well-known details may be omitted so as not to obscure the invention.

The methods for adaptively interfacing with a data repository may be implemented in modules. A module, and in particular its functionality, can be implemented in either hardware or software. In the software sense, a module is a process, program, or portion thereof, that usually performs a particular function or related functions. Such software may be implemented in C, C++, ADA, Fortran, for example, but may be implemented in any of a number of other programming languages/systems, or combinations thereof. In the hardware sense, a module is a functional hardware unit designed for use with other components or modules. For example, a module may be implemented using discrete electronic components, or it can form a portion of an entire electronic circuit such as an Field Programmable Gate Arrays (FPGA), Application Specific Integrated Circuit (ASIC), and the like. A physical implementation may also comprise configuration data for a FPGA, or a layout for an ASIC, for example. Still further, the description of a physical implementation may be in EDIF netlisting language, structural VHDL, structural Verilog or the like. Numerous other possibilities exist. Those skilled in the art will appreciate that the system can also be implemented as a combination of hardware and software modules.

Some portions of the description are explicitly or implicitly presented in terms of algorithms and representations of operations on data within a computer system or other device capable of performing computations, e.g. a personal digital assistant (PDA), a cellular telephone, and the like. These algorithmic descriptions and representations may be used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical, magnetic, or electromagnetic signals capable of being stored, transferred, combined, compared, and otherwise manipulated.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “executing”, “selecting”, “building”, “receiving”, “displaying”, “storing” “launching”, “reporting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses an apparatus or a system for performing the operations of the methods. Such an apparatus may be specially constructed for the required purposes, or may comprise a general-purpose computer or other device selectively activated or reconfigured by a computer program stored in the computer. The algorithms and displays presented herein are not inherently related to any particular computer or other apparatus. Various general-purpose machines may be used with programs in accordance with the teachings herein. Alternatively, the construction of more specialized apparatus to perform the required method steps may be appropriate. The structure of a conventional general-purpose computer appears from the description below.

In addition, embodiments of the present invention may be implemented as a computer program(s) or software. It would be apparent to a person skilled in the art that the individual steps of the methods described herein may be put into effect using computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing the spirit or scope of the invention. Furthermore one or more of the steps of the computer program may be performed in parallel rather than sequentially.

Such a computer program may be stored on any computer readable medium. The computer readable medium may comprise storage devices such as magnetic or optical disks, memory chips, or other storage devices suitable for interfacing with a general-purpose computer. The computer readable medium may also comprise a hard-wired medium such as exemplified in the Internet system, or wireless medium such as exemplified in the GSM mobile telephone system. The computer program when loaded and executed on such a general-purpose computer effectively results in an apparatus that implements the steps of the method(s).

The method(s) may comprise a particular control flow. There are many other variants of the method(s) that use different control flows without departing the spirit or scope of the invention. Furthermore one or more of the steps of the method(s) may be performed in parallel rather sequential.

Overview

The embodiments of the invention provide a user interface designed to connect to an underlying database and provide the user with powerful search, navigation, display and reporting features. Importantly, the user interface can be connected to any database that conforms to a defined standard or framework. Having been “pointed” at a new database, the user interface automatically generates and displays the search and navigation elements, such as menus, search grids and displays. The user interface application is driven by the underlying database. The interface application may be provided details of the database as a parameter(s) of the application to “point” at the database. For web delivery, this may involve providing a URL to a location with a script to run the interface application with details of the database as a parameter.

The user interface builds these elements by interrogating meta-data in the underlying database, which provides information on where text, data, and input objects are to be displayed. From other meta-data tables, the user interface decides which data is displayed for a particular user and whether the users have read and write access. For example, menus of the interface change when the user interface is pointed at a new or different database. The user interface accepts different sets of data and allows a user to navigate and search the data flexibly with minimal or no reprogramming. The user interface makes decisions about the interface elements on the fly using meta-data tables.

The user interface utilises intelligent objects invoked by the user while navigating through the interface screens (i.e., event driven). The objects decide when, if, and how the objects react to the events, depending on the data itself, the particular user, and the data stored in the meta-data tables. Because column headings and widths, sort order, color, fonts, menu items and dropdown box options are all data driven, the user interface does not care what the data actually represents. The look and feel of the user interface is driven by Cascading Style Sheets (CSS). The style sheet to use can also be data driven.

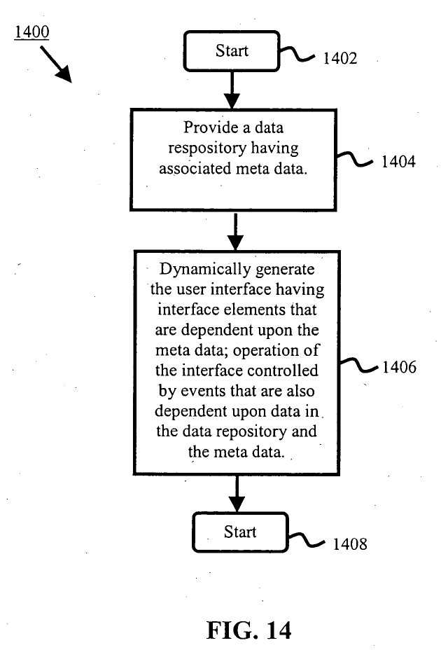

FIG. 14 illustrates a method 1400 of providing an adaptive user interface to a data repository. Processing commences in step 1402. In step 1404, a data repository is provided. The data repository has associated meta-data. In step 1406, the user interface is dynamically generated. The user interface has interface elements that are dependent upon the meta data. Operation of the interface is controlled by events that also are dependent upon data in the data repository and the meta-data. Processing terminates in step 1408. Further details are set forth hereinafter. However, before proceeding further with a more detailed description of the user interface process, a brief overview is provided of a representative system with which the embodiments of the invention may be practiced.

System 100

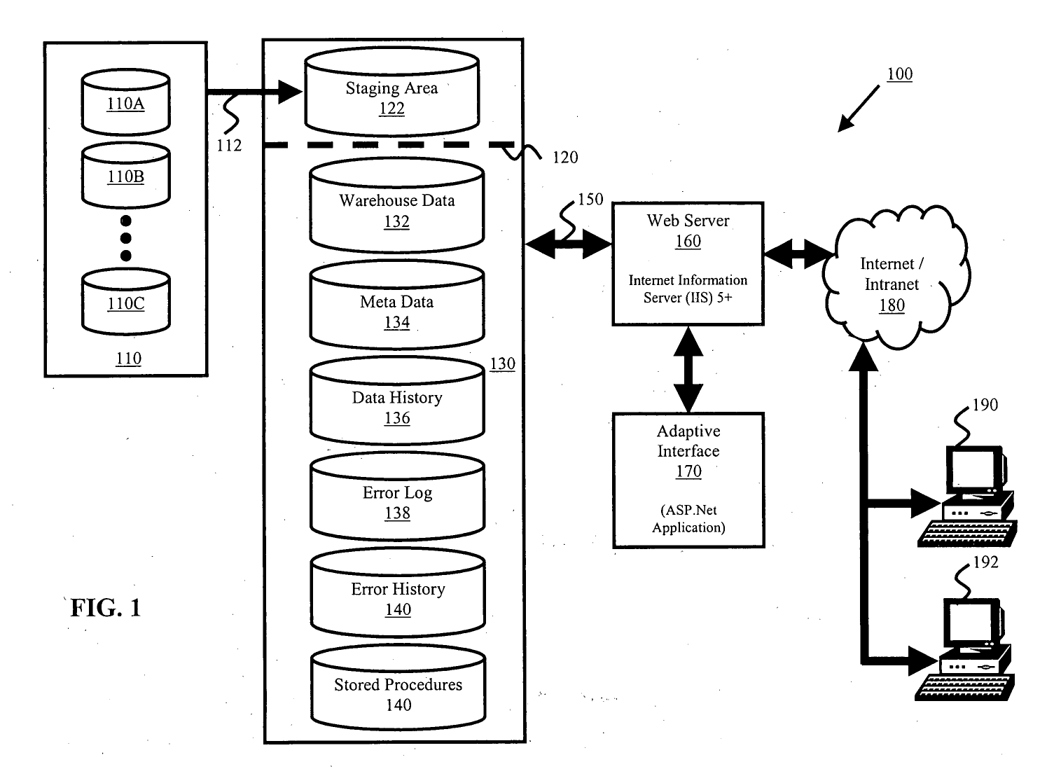

FIG. 1 is a block diagram illustrating a system 100 for adaptively interfacing with a data repository 130. The data repository 130 may be any data set that satisfies a specified framework for the user interface. The system 100 comprises a data repository 130 (e.g., a data warehouse) and an adaptive user interface system 170 coupled to the data repository 130 via a web server 160. The user interface system 170 is preferably implemented as an ASP.Net application, which allows the application to be browser-based. Application Service Provider (ASP) is a specification for dynamically created Web pages with a ASP extension that utilizes ActiveX scripting (e.g., Visual Basic Script or Java script code). When a browser requests an ASP page, the web server 160 generates a page with HTML code and sends the page back to the requesting browser. The user interface may be implemented using library objects in the form of reuseable dll files. Remote users using client systems 190, 192 are coupled to the web server 160 via a network 180, such as the Internet or an Intranet. The remote users can access the data repository, 130 via the user interface 170 using a web browser. The system 100 is therefore capable of delivering data to any browser user in the world that has Internet access, for example.

Preferably but not necessarily, the data repository 130 may be derived from several different database or transaction systems 110. This comprises a number of individual transaction systems 110A, 110B, . . . , 110C, which periodically load data 112 into the data warehouse 130. The individual transaction systems 110A, 110B, . . . , 110C may poorly interact with one or more of the other transaction systems, or not at all. Preferably but not necessarily, a staging area 122 receives the data 112 periodically loaded from the transaction systems 110. The staging area 122 may receive both good and bad data. Data transform rules may be applied between the transaction systems and the staging area, which may produce an intermediate file. Data may be brought into the staging area 112 using variable character field text, for example. Preferably but not necessarily, a virtual quality firewall 120 is maintained between the staging area 122 and the data warehouse 130 to keep bad data out of the data repository 130 and to identify errors in the data from the staging area 122. The data warehouse 130 comprises warehouse data 132 and meta-data 134. Preferably but not necessarily, the data warehouse 130 also comprises a data history 136, an error log 138, an error history 140, and stored procedures 142.

Main Menu

The data necessary to build a main menu using the user interface 170 is retrieved from the meta data 134 and is used to populate an expandable hierarchal or “Tree” structured object that is the main menu. The meta-data 134 provides information such as the following:
sort order,
display name,
hierarchy,
table ID,
target object,
navigation URL, and
initial expansion.

Selecting a menu item invokes a search screen, a list screen, or a detail page, described hereinafter.

Search Screen

Each column of every table is defined in a columns table as part of the meta-data 134. Attributes of each column define the column's participation in objects such as search screens. This data is used to generate each search screen.

List Screen

List screens are driven by a custom-built list object. From using the meta-data 134, the list object generates lists of rows returned by the search-screen, SQL “Where” clause. Column participation, headings, and hyperlinks are all generated from the meta-data. Selection of a row by the user invokes the appropriate detail page.

Detail Page

Detail pages are related to tables (and hence entities in the data). Table and column related meta-data 134 dictates participation of that column, its position on the screen, user access, and the related text heading.

Related Data

Every detail page also has a “Related Data” drop-down box. Population of this box comes from a meta-data table that describes all table joins. Depending on the type of the relationship (parent, child or sibling), the word “All” or “The” is added to the beginning of the display name. For children, where “All” is added to the beginning, an “s” is added to pluralize the last word. For example, consider the situation where a detail page displayed the entity “Customer” and a relationship is described in the Join table where a child table contained many orders relating to that company. In this case, the display name for the orders and customer tables are “Order” and “Customer”, respectively. The listing in the drop-down box is “All Orders”, and when an order is the subject of a detail page, the drop-down box entry reads “The Customer”.

Meta Data Joins

The join table is used for data navigation. Because the joins are defined in the meta data, considerable flexibility is provided. For example, joins need not comprise the primary keys of either table. Therefore, joins can have many-to-many relationships, allowing both tables to act as both a “parent” and “child” table when navigating between the tables.

Furthermore, the meta data associated with the join can also determine a number of join attributes that dictate how the join functions. For example, a number of flags can control whether or not the “parent” or “child” table appears in the related information dropdown box and whether or not certain traditional referential integrity rules are enforced as part of the data integrity checking. Other flags and options can control other functional aspects of the join.

Join Functions

As part of the join meta data, a function can also be added to the join. For example, the same, or similar data may have been entered into two tables in different formats. If so, a conversion function can be included in the join to ensure that the data matches. A simple example comprises a function to strip all non-alphanumeric characters from both sides of the join. This is particularly useful if data had been entered differently and sometimes included embedded dashes, spaces or tab characters. Optionally, a “wizard” allows joins to be established automatically, by selecting the appropriate columns, functions, and meta data options.

Because the joins exist mainly for navigation, joins can be included that would not normally be considered as “valid” joins. For example, unless “date” is a primary key, a database does not normally include a join between two “date” columns of two tables. However, simply including a join between these columns allows the user to find, and navigate to, all the rows in table B that match a particular date in table A, and vice versa.

Hard Joins

Using meta data to describe the table joins does not exclude the use of the underlying DataBase Management System (DBMS) to establish table joins. In fact, where referential integrity must be enforced, “hard” joins may also be added using the DBMS.

Reporting

Because all search screens accept wild cards, the search screens can return almost any set of rows as a subset of the data. These rows are used to generate either spreadsheet or database files, e.g., using Microsoft Access™ or Excel™ files. Users can then either use the data directly, or manipulate the data further, as necessary.

Managing Meta Data

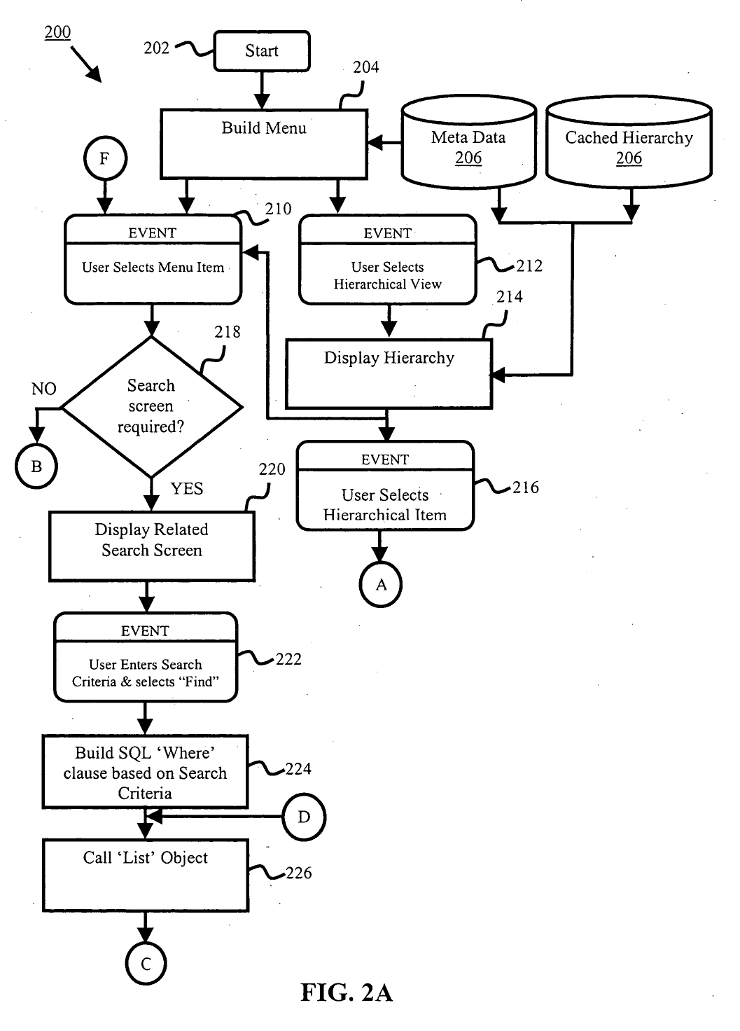

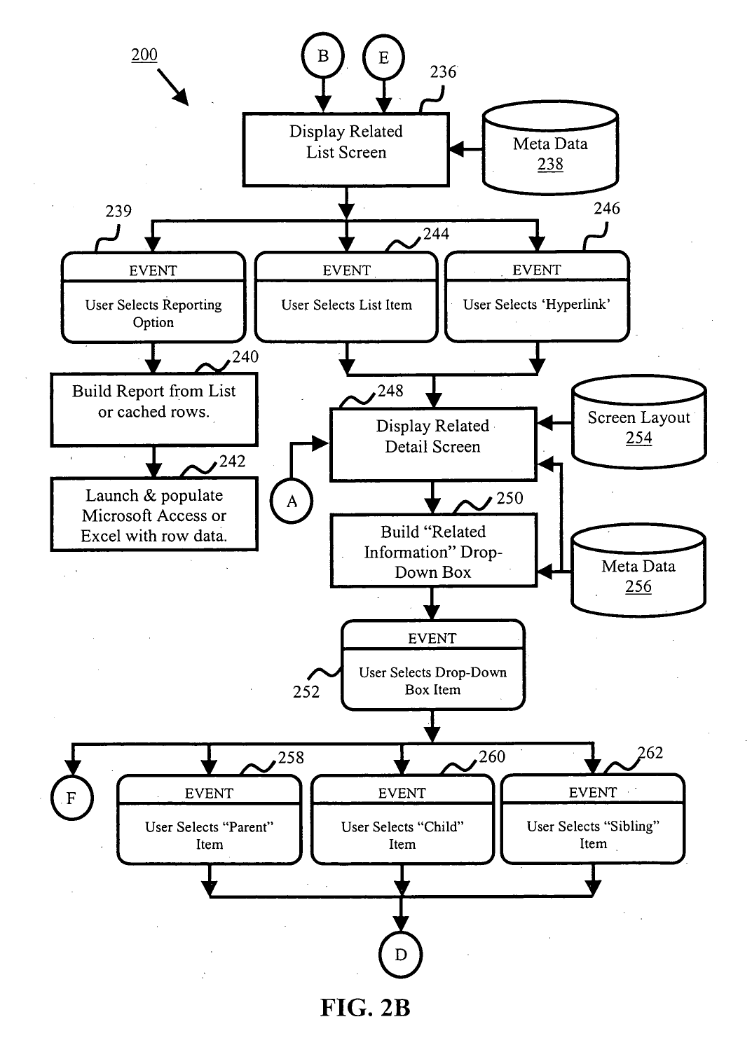

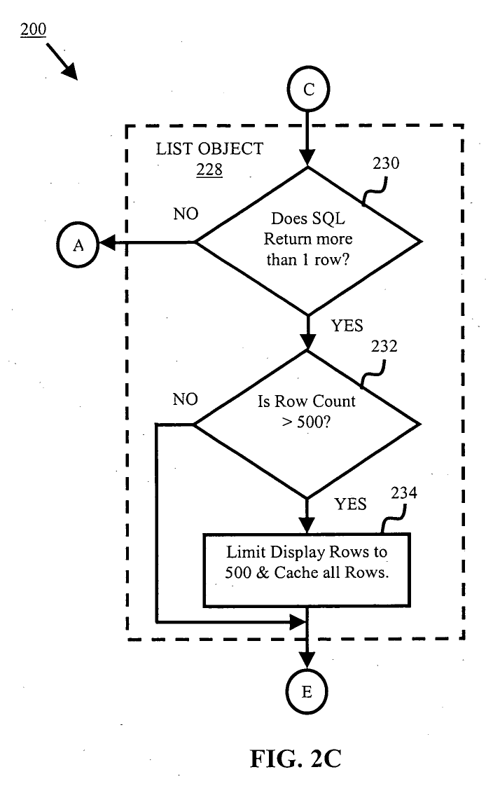

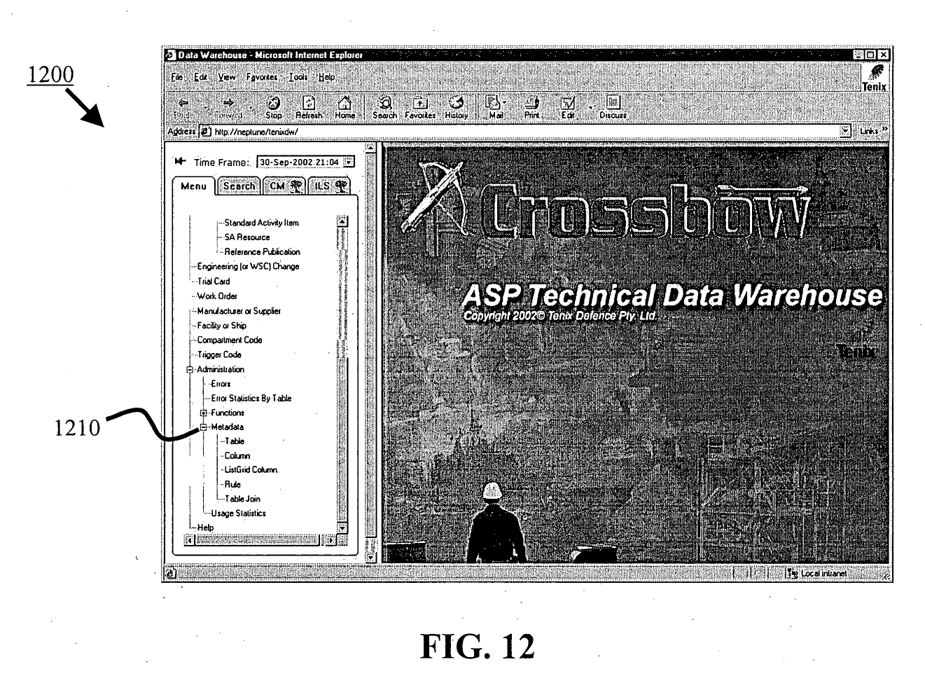

Because the user interface 170 can also access meta-data tables, the meta-data 134 can be treated just like any other data in the database 130. Therefore, most of the meta-data 134 can be edited in a series of administration screens (see FIG. 12). The relationship between the meta-data tables is also described in the join, column and table tables. Therefore, the meta-data tables can also be navigated in the same way that other data is treated. These and other aspects are described in greater detail hereinafter with reference to FIG. 2.

User Interface Process 200

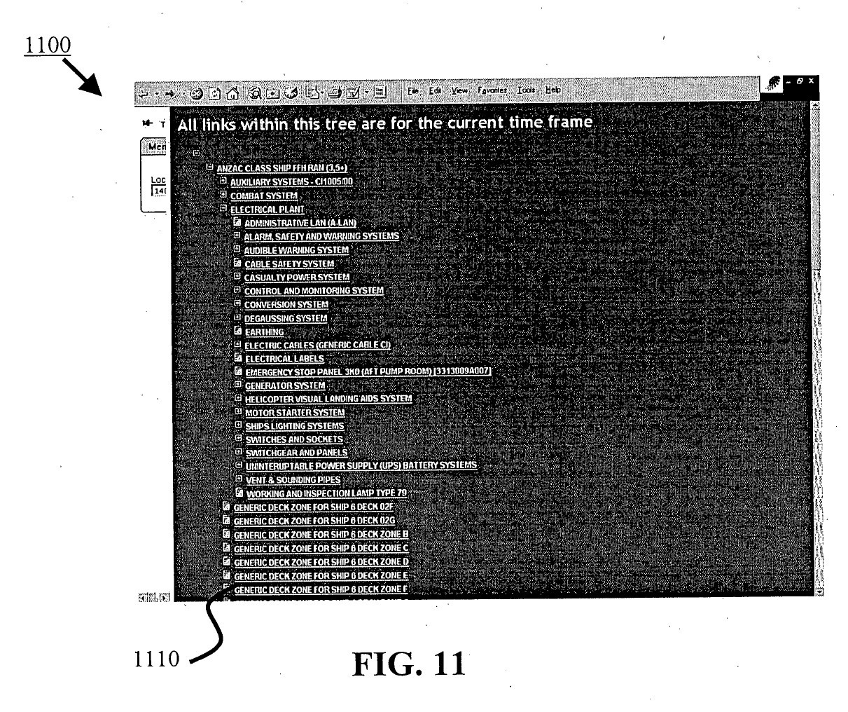

FIGS. 2A, 2B, and 2C are a flow diagram illustrating the process 200 of adaptively interfacing with a data repository. The data repository may be derived from the different transaction systems of FIG. 1. Processing commences in step 202. In step 204, a main menu is built using meta-data 206 (134 in FIG. 1), as described hereinbefore. From step 204, two events 210 and 212 may occur. In step 210, an event can occur in which the user selects a menu item. A menu item provides an entity name. In parallel with step 210, processing from step 204 can continue at step 212. In step 212, an event can occur in which the user selects a hierarchical view (see FIG. 11). There may be two or more hierarchical views. A hierarchical view is an alternate way of getting at data. In step 214, the hierarchy is displayed dependent upon the meta-data 206 and a cached hierarchy 208. Because the hierarchy does not change between data loads, the hierarchical structure may be cached (208). The processing and resources required to build the hierarchical view of the data is consequently only done once per data load in such circumstances. For some entities in the data, there is a relationship between rows in a table, i.e., a recursive relationship. Within a table, the relationship may be displayed as a hierarchy. Normally, a table is searched and a parent-child relationship is built between rows. The cached hierarchy 206 stores the parent information about a row. From step 214, an event can occur in step 216, in which the user selects a hierarchical item from the hierarchical display. From step 216, processing continues at step 248. From step 214, processing may continue at step 210. From step 210, processing continues at step 218.

In decision step 218, a check is made to determine if a search screen is required. A search screen is built from a menu item. If step 218 returns false (NO), processing continues at step 236. In step 236, a related list screen is displayed. Otherwise, if step 218 returns true (YES), processing continues at step 220. In step 220, a related list search screen is displayed. In step 222, an event can occur in which a user enters search criteria and selects a “Find” command. Search criteria may be entered in one or more fields, and the user may specify wild cards. In step 224, a SQL “Where” clause is built based on the search criteria from step 222. In step 226, a “List” object is called. The list object contains data returned from the “where” clause. The list object 228 involves steps 230, 232, and 234. In decision step 230, a check is made to determine if the SQL command returns more than one row. If step 230 returns false (NO), processing continues at step 248. If zero rows are returned, a message is displayed stating that no records have been found (not shown). Otherwise, if step 230 returns true (YES), processing continues at step 232. In decision step 232, a check is made to determine if the row count exceeds a given or predetermined number (e.g., 500). If decision step 232 returns false (NO), processing continues at step 236. Otherwise, if step 232 returns true (YES), processing continues at step 234. In step 234, the display rows are limited to the predetermined or given number of step 232 (e.g., 500), and all rows are cached. Processing then continues at step 236.

In step 236, a related list screen is displayed dependent upon meta-data 238. From step 236, three events 238, 244, and 246 may occur. In step 239, an event can occur in which the user selects a reporting option, following step 236. In step 240, a report is built from the list or cached rows. In step 242, a database or spreadsheet application (e.g., Microsoft Access or Microsoft Excel) is launched and populated with row data. Otherwise, from step 236, processing may continue at step 244 or 246. In step 244, an event occurs in which a user selects a list item. In step 246, the user selects a hyperlink. A column heading may be underlined allowing the user to move from the location to an item. From steps 244 or 246, processing continues at step 248.

In step 248, a related detail screen is displayed based on meta-data 256 and screen layout information 254. In step 250, a related information, drop-down box is built dependent upon meta-data 256. This step uses a join table. Meta data is interrogated to find all possible relationships to other entities in the database. From step 250, an event can occur in step 252 in which the user selects the drop-down box item. From step 252, four events 210, 258, 260, and 262 can occur. In step 258, an event can occur in which the user selects a “Parent” item. In step 260, an event can occur in which the user selects a “Child” item. In step 262, an event can occur in which the user selects a “Sibling” item. From each of steps 258, 260, and 262, processing continues at step 226.

Thus, by using meta-data 134 to describe the relationship between the various elements, a single user interface can be used to search, navigate, display, edit and report data from many different databases. Simply designing a new data tier can generate new end-user applications. The user interface is also a software application development environment. Developers need only develop their application at the data tier level. The user interface then becomes the user interface for the application, automatically adapting to the new data. This saves design effort and the necessity to program a new user interface. The adaptability of the user interface is achieved by using meta-data tables within the data repository. Such tables are easier to generate and maintain than rewriting the software application. The user interface allows a user to start from any point, with whatever piece of data the user has, and then search and navigate through the data repository to the needed information. The user interface can easily be transported to other sets of data. Adding additional data is relatively simple.

The user interface may also be implemented as a standalone application together with its own data. The data may be periodically updated using a CDROM, or via network access, for example.

Screenshots

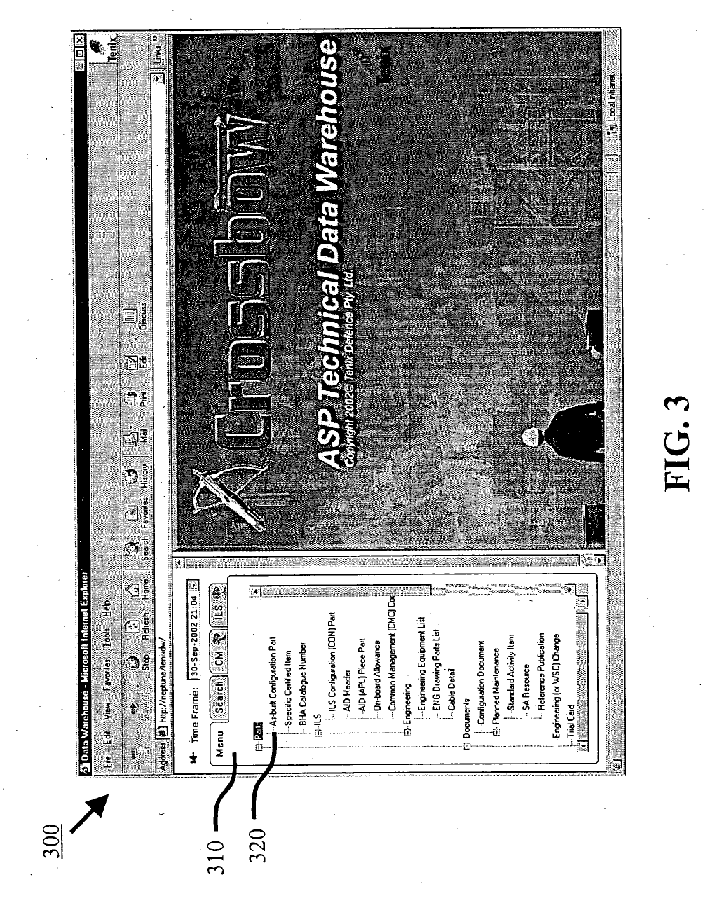

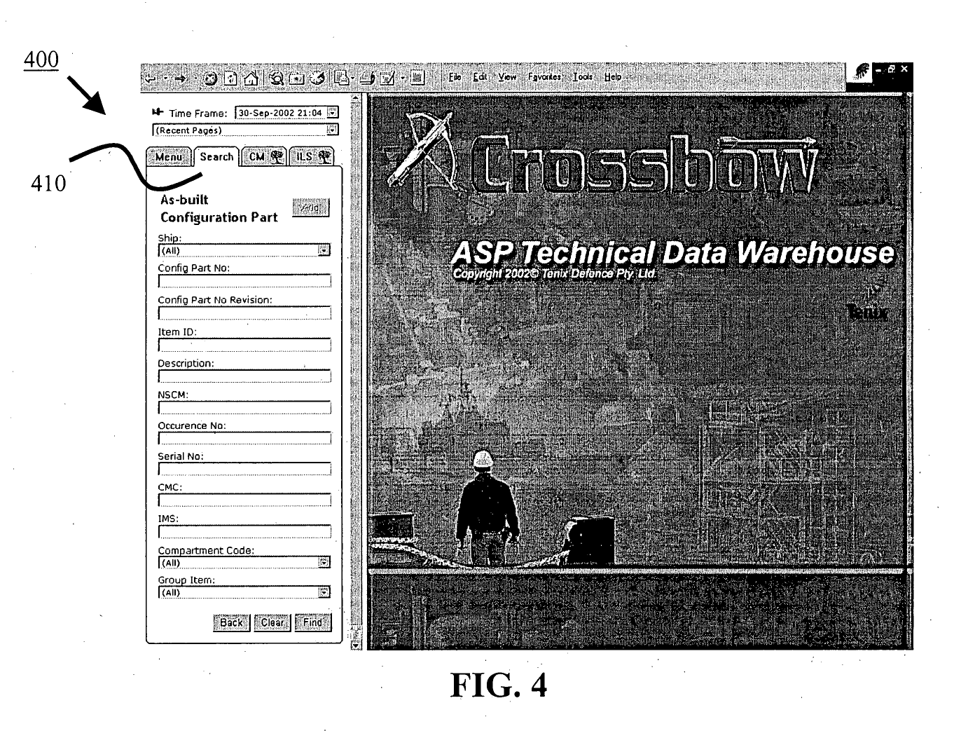

Several representative screenshots are depicted in FIGS. 3-12 to illustrate the appearance of the interface produced by the process 200 of FIG. 2. The screenshots are of a browser utilising the adaptive user interface to access data. In the screenshots, the Microsoft Internet Explorer browser is used.

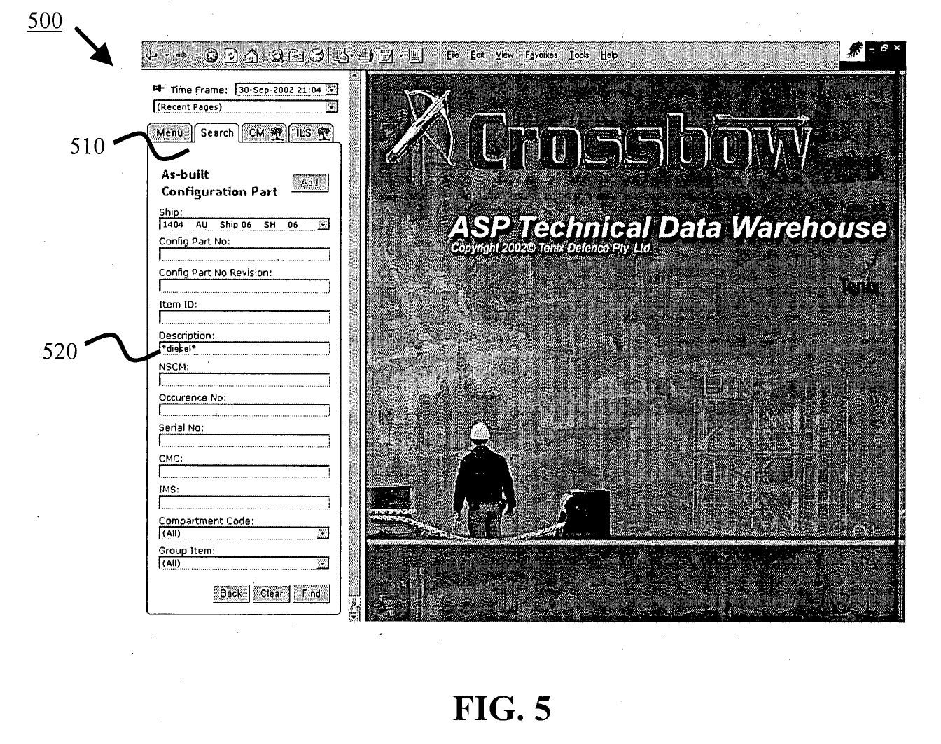

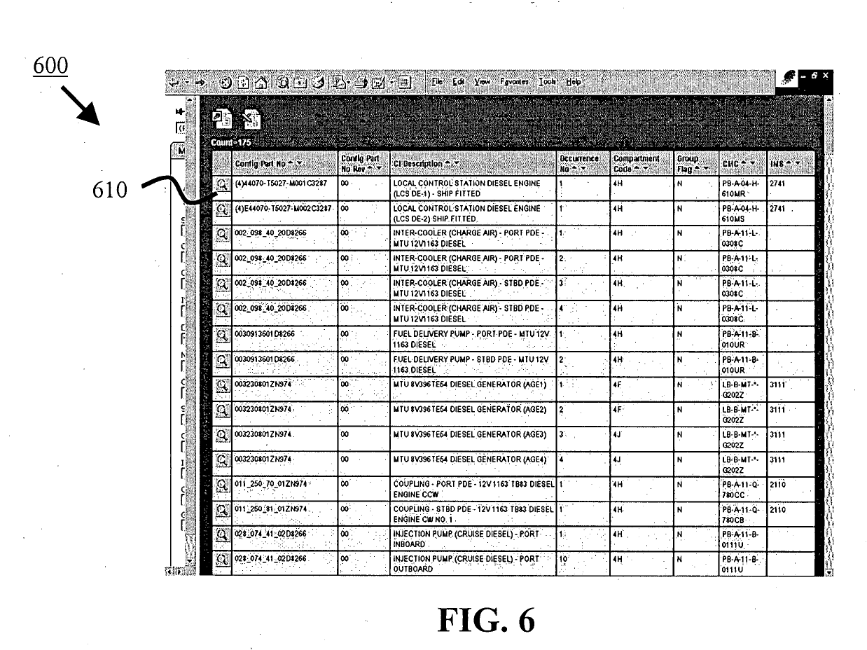

FIG. 3 illustrates a screenshot 300 of the interface produced. The main menu 310 is shown for the current database or repository pointed to. A number of items are shown in the main menu 310, comprising an item 320 “As-built Configuration Part”. Also shown in the interface is a time frame, indicating the stored history. If the item 320 is clicked on, the screenshot 400 of the interface is produced, labelled “As-built Configuration Part”. The search screen 410 is shown. The fields shown in the search screen 410 and what type of fields are dependent upon the meta-data. As shown in FIG. 5, by filling in the description field 520 in the search screen 510 with “diesel” and clicking find, the list grid 600 of 175 items is produced, as shown in FIG. 6. Each of the items may be clicked on for more details. Clicking on the topmost item 610 produces a related detail screen (248 in FIG. 2).

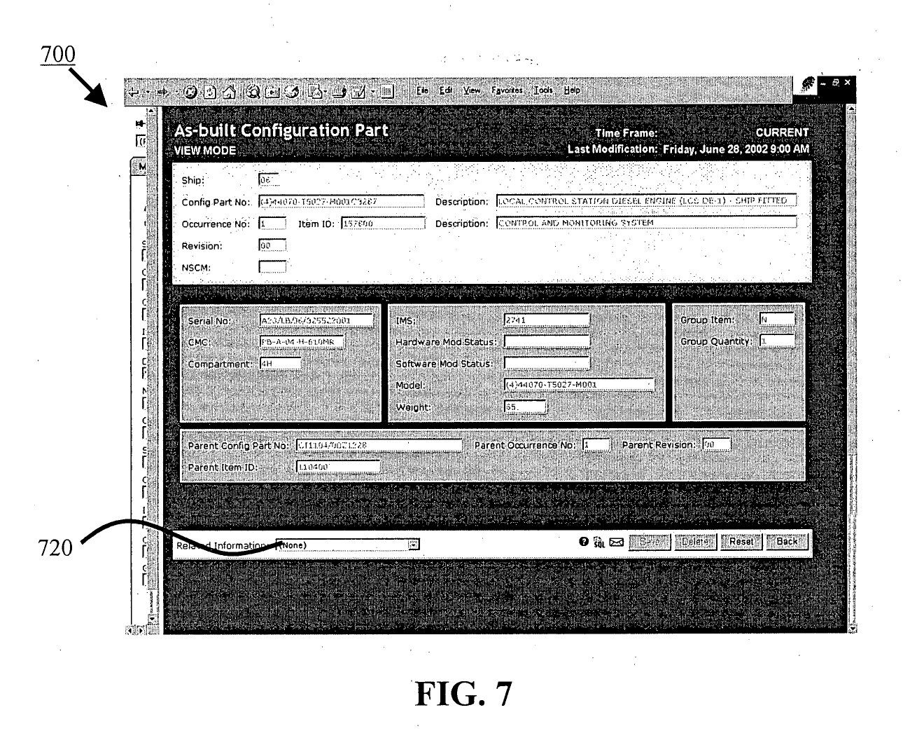

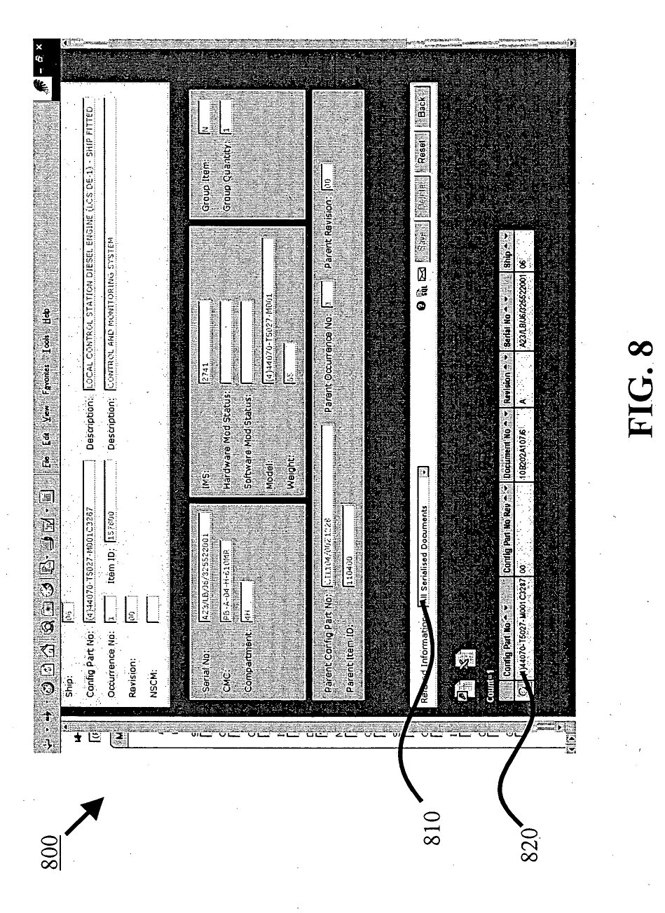

FIG. 7 is the resulting screenshot 700 of the related detail screen, from clicking on item 610. This is the result of a “Where” statement built using “diesel” from the search screen. A related information box 720 is depicted with “None” specified. FIG. 8 is a screenshot 800 that results by selecting “All Serialised Documents” 810 in the box 720 of FIG. 7. One serialised document 820 is depicted as a result. This is a related item “child” (260 in FIG. 2).

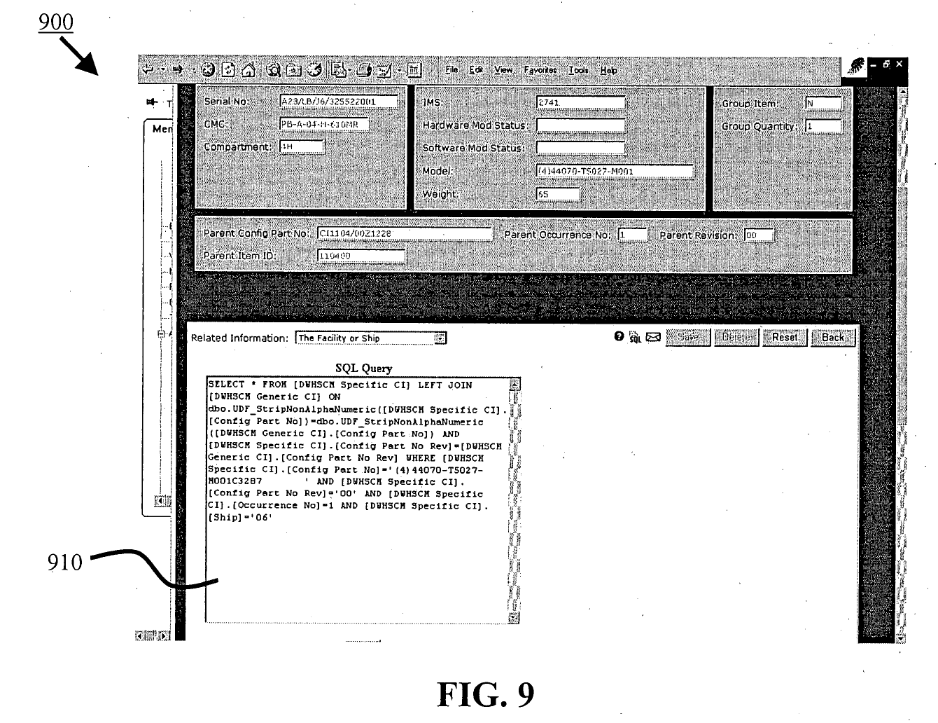

FIG. 9 is a screenshot 900 depicting details of a SQL query 910, produced by step 224 of FIG. 2. This can be shown by clicking on the SQL icon in FIG. 9.

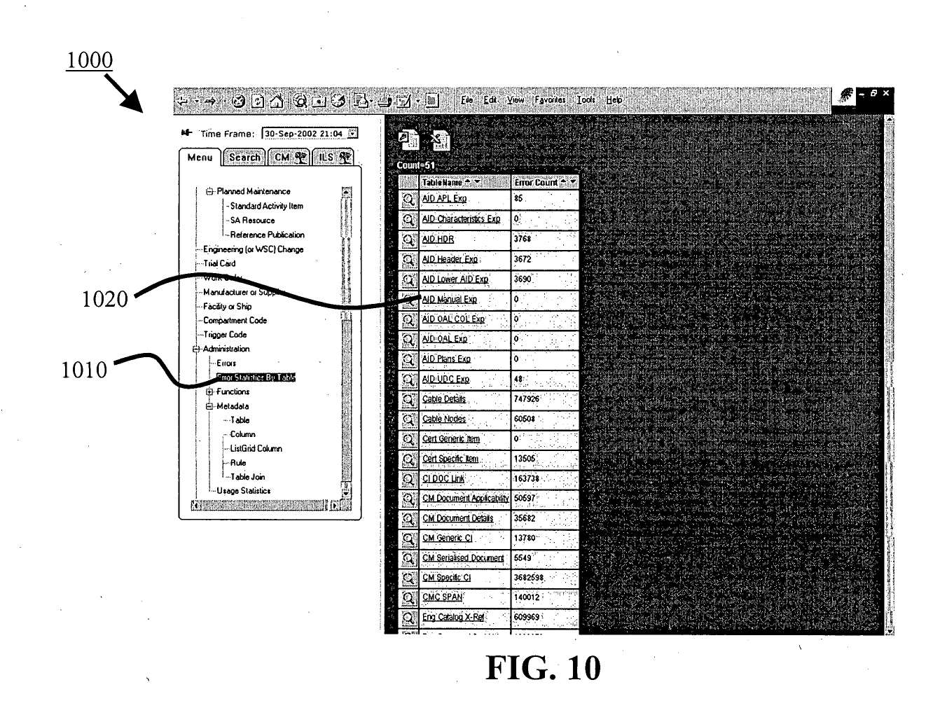

FIG. 10 is a screenshot 1000 providing further details of the main menu. One of the items in the main menu is the Administration item, which has a child element 1010 “Error Statistics by Table”. This is an example of an administrative function available through the user interface. A list 1020 of 51 tables and the corresponding error count are produced.

FIG. 11 is a screenshot 1100 showing a hierarchical view (step 214 of FIG. 2) showing all links 1110 within the tree. The links 1110 are hyperlinks to items in the database. Each represents a row.

Finally, FIG. 12 is a screenshot 1200 illustrating meta-data administrative functions 1210 illustrating that the interface can be used to access and modify the meta data tables.

Thus, the embodiments of the invention provide a largely generic user interface, capable of attaching to a wide set of databases. The initial menu and all sub-menus are all generated from the underlying database. Most of the necessary information is held in pre-defined meta data tables. The advantages of this approach comprise:
A single user interface can be reused in a number of applications;
New applications can be written quickly and inexpensively;
Users skilled in one application can learn a new application more quickly;
Changes to the data tier often do not require changes to the user interface; and
In summary, applications are easier to develop and maintain, and therefore are less expensive.
   Computer Implementation

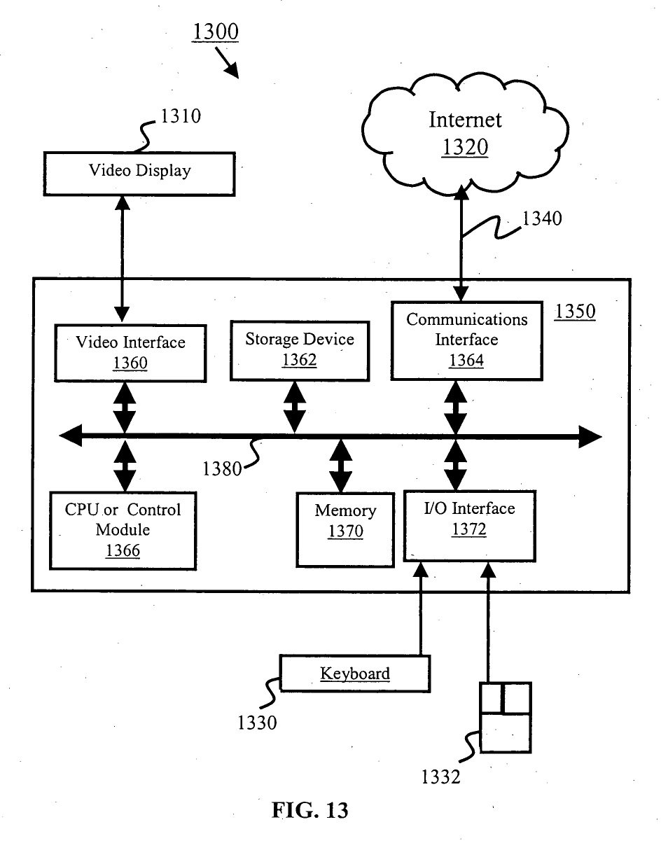

The method of adaptively interfacing with a data repository may be practiced using one or more general-purpose computer systems, in which the processes of FIGS. 1-12 and 13 may be implemented as software, such as an application program executing within the computer system or handheld device. In particular, the steps of method of adaptively interfacing with a data repository are effected, at least in part, by instructions in the software that are carried out by the computer. The instructions may be formed as one or more code modules, each for performing one or more particular tasks. The software may be stored in a computer readable medium, comprising the storage devices described below, for example. The software is loaded into the computer from the computer readable medium, and then executed by the computer. A computer readable medium having such software or computer program recorded on it is a computer program product. An example of a computer system 1300 with which the embodiments of the invention may be practiced is depicted in FIG. 13.

In particular, the software may be stored in a computer readable medium, comprising one or more of the storage devices described hereinafter. The software is loaded into the computer from the computer readable medium and then carried out by the computer. A computer program product comprises a computer readable medium having such software or a computer program recorded on the medium that can be carried out by a computer. The use of the computer program product in the computer may effect an advantageous apparatus for ensuring data quality and integrity of a data set derived from a data source in accordance with the embodiments of the invention.

The computer system 1300 may comprise a computer 1350, a video display 1310, and one or more input devices 1330, 1332. For example, an operator can use a keyboard 730 and/or a pointing device such as the mouse 1332 (or touchpad, for example) to provide input to the computer. The computer system may have any of a number of other output devices comprising line printers, laser printers, plotters, and other reproduction devices connected to the computer. The computer system 1300 can be connected to one or more other computers via a communication interface 1364 using an appropriate communication channel 1340 such as a modem communications path, a computer network, a wireless LAN, or the like. The computer network may comprise a local area network (LAN), a wide area network (WAN), an Intranet, and/or the Internet 1320, for example.

The computer 1350 may comprise one or more central processing unit(s) 1366 (simply referred to as a processor hereinafter), memory 1370 which may comprise random access memory (RAM) and read-only memory (ROM), input/output (IO) interfaces 1372, a video interface 1360, and one or more storage devices 1362. The storage device(s) 1362 may comprise one or more of the following: a floppy disc, a hard disc drive, a magneto-optical disc drive, CD-ROM, DVD, a data card or memory stick, magnetic tape or any other of a number of non-volatile storage devices well known to those skilled in the art. For the purposes of this description, a storage unit may comprise one or more of the memory 1370 and the storage devices 1362.

Each of the components of the computer 1350 is typically connected to one or more of the other devices via one or more buses 1380, depicted generally in FIG. 13, that in turn comprise data, address, and control buses. While a single bus 1380 is depicted in FIG. 13, it will be well understood by those skilled in the art that a computer or other electronic computing device such as a PDA or cellular phone may have several buses including one or more of a processor bus, a memory bus, a graphics card bus, and a peripheral bus. Suitable bridges may be utilised to interface communications between such buses. While a system using a processor has been described, it will be appreciated by those skilled in the art that other processing units capable of processing data and carrying out operations may be used instead without departing from the scope and spirit of the invention.

The computer system 1300 is simply provided for illustrative purposes and other configurations can be employed without departing from the scope and spirit of the invention. Computers with which the embodiment can be practiced comprise IBM-PC/ATs or compatibles, one of the Macintosh™ family of PCs, Sun Sparcstation™, a workstation or the like. The foregoing are merely examples of the types of computers with which the embodiments of the invention may be practiced. Typically, the processes of the embodiments, described hereinafter, are resident as software or a program recorded on a hard disk drive as the computer readable medium, and read and controlled using the processor. Intermediate storage of the program and intermediate data and any data fetched from the network may be accomplished using the semiconductor memory.

Still further, the software can also be loaded into the computer system from other computer readable media. The term “computer readable medium” as used herein refers to any storage or transmission medium that participates in providing instructions and/or data to the computer system for execution and/or processing. Examples of storage media comprise floppy disks, magnetic tape, CD-ROM, a hard disk drive, a ROM or integrated circuit, a magneto-optical disk, or a computer readable card such as a PCMCIA card and the like, whether or not such devices are internal or external of the computer module. Examples of transmission media comprise radio or infra-red transmission channels as well as a network connection to another computer or networked device, and the Internet or Intranets comprising e-mail transmissions and information recorded on Websites and the like.

A small number of embodiments of the invention regarding methods, systems, and computer program products for adaptively interfacing with a data repository have been described. In the light of the foregoing, it will be apparent to those skilled in the art in the light of this disclosure that various modifications and/or substitutions may be made without departing from the scope and spirit of the invention.

1. A method of providing an adaptive user interface to a data repository, said method comprising the steps of:
providing a data repository, said data repository having associated meta-data; and
dynamically generating said user interface having interface elements that are dependent upon said meta data, operation of said interface controlled by events that also are dependent upon data in said data repository and said meta-data.

2. The method according to claim 1, wherein said generating step comprises the step of checking said data repository to ensure said database has associated meta-data, said meta-data defining relationships in said data repository

3. The method according to claim 2, wherein said generating step further comprises the step of building a menu as a tree object using said meta-data, levels in said tree being built from said meta-data.

4. The method according to claim 1, further comprising the step of accessing said user interface using a browser.

5. The method according to claim 4, further comprising the step of generating web pages for delivery to said browser to provide said user interface.

6. The method according to claim 1, wherein said interface elements comprise a main menu, said main menu being an expandable, hierarchically structured object.

7. The method according to claim 6, further comprising the step of building said main menu dependent upon said meta data.

8. The method according to claim 1, wherein said meta-data comprises any one or more of the following:
sort order,
display name,
hierarchy,
table ID,
target object,
navigation URL, and
initial expansion.

9. The method according to claim 7, further comprising the step of invoking a search screen, a list screen or a detail page if a menu item is selected.

10. The method according to claim 1, further comprising the steps of automatically generating and displaying search and navigation elements of said user interface.

11. The method according to claim 1, further comprising the step of providing at least one parameter pointing at said data repository to dynamically generate said user interface.

12. The method according to claim 11, further comprising the step of providing a universal resource locator (URL) to a script location to run said user interface with said data repository as a parameter.

13. The method according to claim 1, further comprising the steps of:
providing another data repository, said other data repository having associated meta-data; and
dynamically generating said user interface having different interface elements that are dependent upon said meta data of said other data repository, operation of said interface controlled by events that also are dependent upon data in said other data repository and said meta-data.

14. The method according to claim 1, wherein said data repository is derived from a plurality of different database or transaction systems.

15. An apparatus for providing an adaptive user interface to a data repository, said apparatus comprising:
a data repository having associated meta-data; and
means for dynamically generating said user interface having interface elements that are dependent upon said meta data, operation of said interface controlled by events that also are dependent upon data in said data repository and said meta-data.

16. The apparatus according to claim 15, wherein said generating means comprises means for checking said data repository to ensure said database has associated meta-data, said meta-data defining relationships in said data repository.

17. The apparatus according to claim 16, wherein said generating means further comprises means for building a menu as a tree object using said meta-data, levels in said tree being built from said meta-data.

18. The apparatus according to claim 15, further comprising a browser for accessing said user interface.

19. The apparatus according to claim 18, further comprising means for generating web pages for delivery to said browser to provide said user interface.

20. The apparatus according to claim 15, wherein said interface elements comprise a main menu, said main menu being an expandable, hierarchically structured object.

21. The apparatus according to claim 20, further comprising means for building said main menu dependent upon said meta data.

22. The apparatus according to claim 15, wherein said meta-data comprises any one or more of the following:
sort order,
display name,
hierarchy,
table ID,
target object,
navigation URL, and
initial expansion.

23. The apparatus according to claim 21, further comprising means for invoking a search screen, a list screen or a detail page if a menu item is selected.

24. The apparatus according to claim 15, further comprising means for automatically generating and displaying search and navigation elements of said user interface.

25. The apparatus according to claim 15, further comprising means for providing at least one parameter pointing at said data repository to dynamically generate said user interface.

26. The apparatus according to claim 25, further comprising means for providing a universal resource locator (URL) to a script location to run said user interface with said data repository as a parameter.

27. The apparatus according to claim 15, further comprising:
another data repository having associated meta-data; and
means for dynamically generating said user interface having different interface elements that are dependent upon said meta data of said other data repository, operation of said interface controlled by events that also are dependent upon data in said other data repository and said meta-data.

28. The apparatus according to claim 15, wherein said data repository is derived from a plurality of different database or transaction systems.

29. A computer program product for providing an adaptive user interface to a data repository, said computer program product comprising:
computer program code means for providing a data repository having associated meta-data; and
computer program code means for dynamically generating said user interface having interface elements that are dependent upon said meta data, operation of said interface controlled by events that also are dependent upon data in said data repository and said meta-data.

30. The computer program product according to claim 29, wherein said computer program code means for generating comprises computer program code means for checking said data repository to ensure said database has associated meta-data, said meta-data defining relationships in said data repository.

31. The computer program product according to claim 30, wherein said computer program code means for generating further comprises computer program code means for building a menu as a tree object using said meta-data, levels in said tree being built from said meta-data.

32. The computer program product according to claim 29, further comprising computer program code means for accessing said user interface using a browser.

33. The computer program product according to claim 32, further comprising computer program code means for generating web pages for delivery to said browser to provide said user interface.

34. The computer program product according to claim 29, wherein said interface elements comprise a main menu, said main menu being an expandable, hierarchically structured object.

35. The computer program product according to claim 34, further comprising computer program code means for building said main menu dependent upon said meta data.

36. The computer program product according to claim 29, wherein said meta-data comprises any one or more of the following:
sort order,
display name,
hierarchy,
table ID,
target object,
navigation URL, and
initial expansion.

37. The computer program product according to claim 35, further comprising computer program code means for invoking a search screen, a list screen or a detail page if a menu item is selected.

38. The computer program product according to claim 29, further comprising computer program code means for automatically generating and displaying search and navigation elements of said user interface.

39. The computer program product according to claim 29, further comprising computer program code means for providing at least one parameter pointing at said data repository to dynamically generate said user interface.

40. The computer program product according to claim 39, further comprising computer program code means for providing a universal resource locator (URL) to a script location to run said user interface with said data repository as a parameter.

41. The computer program product according to claim 29, further comprising:
computer program code means for providing another data repository having associated meta-data; and
computer program code means for dynamically generating said user interface having different interface elements that are dependent upon said meta data of said other data repository, operation of said interface controlled by events that also are dependent upon data in said other data repository and said meta-data.

42. The computer program product according to claim 29, wherein said data repository is derived from a plurality of different database or transaction systems.

43. A system for adaptively interfacing with a data repository, said system comprising:
a data repository comprising a data set and meta data;
a server coupled to said data repository;
a dynamically generated adaptive interface coupled to said server, said user interface having interface elements that are dependent upon said meta data, operation of said interface being controlled by events that also are dependent upon data in said data repository and said meta-data.

44. The system according to claim 43, wherein said data set satisfies a specified framework of said adaptive interface.

45. The system according to claim 43, wherein said meta-data defines relationships in said data repository.

46. The system according to claim 45, wherein a menu is built as a tree object using said meta-data, levels in said tree being built from said meta-data.

47. The system according to claim 43, further comprising a browser to access said user interface via said server.

48. The system according to claim 47, wherein said server is a web server and generates web pages for delivery to said browser.

49. The system according to claim 43, wherein said interface elements comprise a main menu, said main menu being an expandable, hierarchically structured object.

50. The system according to claim 49, wherein said main menu is built dependent upon said meta data.

51. The system according to claim 43, wherein said meta-data comprises any one or more of the following:
sort order,
display name,
hierarchy,
table ID,
target object,
navigation URL, and
initial expansion.

52. The system according to claim 50, wherein a search screen, a list screen or a detail page is invoked if a menu item is selected.

53. The system according to claim 43, wherein search and navigation elements of said user interface are automatically generated and displayed.

54. The system according to claim 43, further comprising at least one parameter pointing at said data repository to dynamically generate said user interface.

55. The system according to claim 54, further comprising a universal resource locator (URL) pointing to a script location to run said user interface with said data repository as a parameter.

56. The system according to claim 43, further comprising another data repository having associated meta-data, and wherein said user interface is dynamically generated having different interface elements that are dependent upon said meta data of said other data repository, operation of said interface being controlled by events that also are dependent upon data in said other data repository and said meta-data.

56. (canceled)

57. A system providing an adaptive user interface to a data repository, said system comprising:
a storage unit for storing data and computer program code to be carried out by a processing unit;
a processing unit coupled to said storage unit, said processing unit being programmed with said computer program code to:
access a data repository having associated meta data; and
dynamically generate said user interface having interface elements that are dependent upon said meta data, operation of said interface controlled by events that also are dependent upon data in said data repository and said meta-data.

58. The system according to claim 57, wherein said processing unit is programmed with said computer program code to check said data repository to ensure said database has associated meta-data, said meta-data defining relationships in said data repository.

59. The system according to claim 58, wherein said processing unit is programmed with said computer program code to build a menu as a tree object using said meta-data, levels in said tree being built from said meta-data.

60. The system according to claim 57, wherein said processing unit is programmed with said computer program code to access said user interface using a browser.

61. The system according to claim 60, wherein said processing unit is programmed with said computer program code to generate web pages for delivery to said browser to provide said user interface.

62. The system according to claim 57, wherein said interface elements comprise a main menu, said main menu being an expandable, hierarchically structured object.

63. The system according to claim 62, wherein said processing unit is programmed with said computer program code to build said main menu dependent upon said meta data.

64. The system according to claim 57, wherein said meta-data comprises any one or more of the following:
sort order,
display name,
hierarchy,
table ID,
target object,
navigation URL, and
initial expansion.

65. The system according to claim 63, wherein said processing unit is programmed with said computer program code to invoke a search screen, a list screen or a detail page if a menu item is selected.

66. The system according to claim 57, wherein said processing unit is programmed with said computer program code to automatically generate and display search and navigation elements of said user interface.

67. The system according to claim 57, wherein said processing unit is programmed with said computer program code to provide at least one parameter pointing at said data repository to dynamically generate said user interface.

68. The system according to claim 67, wherein said processing unit is programmed with said computer program code to provide a universal resource locator (URL) to a script location to run said user interface with said data repository as a parameter.

69. The system according to claim 57, wherein said processing unit is programmed with said computer program code to:
access another data repository having associated meta-data; and
dynamically generate said user interface having different interface elements that are dependent upon said meta data of said other data repository, operation of said interface controlled by events that also are dependent upon data in said other data repository and said meta-data.

70. The system according to claim 57, wherein said data repository is derived from a plurality of different database or transaction systems.

71. The system according to claim 43, wherein said data repository is derived from a plurality of different database or transaction systems.
